(19) United States
(12) Patent Application Publication
(10) Pub. No.: US 2022/0126322 A1
(43) Pub. Date: Apr. 28, 2022

(54) PROTECTIVE COVER FOR TROMMEL FRAME

(71) Applicant: FLSmidth A/S, Valby (DK)

(72) Inventor: Vicente Oliver Rodriguez, Santiago (CL)

(21) Appl. No.: 17/257,794

(22) PCT Filed: Jul. 2, 2019
(86) PCT No.: PCT/IB2019/055641

§ 371 Date: Jan. 4, 2021

Related U.S. Application Data
(60) Provisional application No. 62/693,131, filed on Jul. 2, 2018.

(51) Int. Cl. B07B 1/18; B07B 1/46

(52) U.S. Cl. CPC B07B 1/185; B07B 1/4645

(57) ABSTRACT

A protective cover (10) for removably affixing to a trommel frame section (1) of a trommel device may be configured to protect portions of the trommel frame section (1) from abrasion and wear from screened material (30) being processed by the trommel device. The protective cover (10) may comprise a body (19); fixation members (11) extending from the body (19); one or more locking features (15) provided to the fixation members (11) for securing the body (19) to the trommel frame section (1); and, an opening (17) provided between the fixation members (11). A trommel device or trommel frame section (1)

### TECHNICAL FIELD

This disclosure relates generally to systems and methods for protecting non-consumable components of industrial equipment. Specifically, this disclosure relates to sacrificial wear parts for protecting certain structural components of a trommel device, such as a trommel frame, sections of a trommel frame, components of a trommel frame, and/or surfaces thereof.

### BACKGROUND OF THE INVENTION

Trommel devices use a trommel frame which supports consumable screen media (i.e., “trommel screen”). The trommel frame generally consists of welded angle iron and/or welded stock (e.g., metal bar stock). The components of the trommel frame may, for instance, comprise solid rectangular bar stock.

Trommel devices are typically employed at discharge ends of grinding mills, but they may be used in a variety of applications (e.g., placer mining). Trommel devices are typically tubular and cylindrical in shape. They rotate, allowing material therein to be separated by the screen media.

Trommel devices may be used to separate liquids from solids, and/or smaller solids from larger solids.

The screen media may be installed within a trommel device, using various installation methods and specifications. The screen media may be secured to a trommel frame in a variety of manners. The trommel frame may serve to radially support the screen media.

Examples of trommel devices and/or screen media can be seen from companies like the Schenck Process Group (e.g., SCREENEX® modular screen panels) and The Multotec Group.

While the screen media used with trommel devices is generally considered to be a consumable wear part and is expected to wear out over time and be periodically removed and eventually replaced with new screen media, trommel frames and components thereof involve more expensive parts and are not intended to be frequently removed or replaced like the screen media. Components of trommel frames are, therefore, generally not considered to be consumable.

Although the structure of a trommel frame is typically protected by an outer rubber coating, lining, or bolt-on mat, currently, operators of trommel devices must perform unplanned tasks of repairing the rubber coating or lining—or, repairing/replacing worn sections of a trommel frame. This requires significant allocations of maintenance downtime, material, and human resources. Failure to perform routine scheduled maintenance or repairs to trommel frames can lead to losses of trommel device equipment warranties, premature failures of trommel frame structures, erosion, abrasion, and wear of underlying metal substrates, decreased trommel frame life, and even potential safety risks to those who may be working around trommel devices.

### OBJECTS OF THE INVENTION

Therefore it is proposed that a design for a trommel device incorporates a temporary, semi-permanent protective cover that is cheaply produced, easy to install and remove from a section of a trommel frame, and which can take up most of the wear as a sacrificial consumable, so that portions of a trommel frame can be protected from wear caused by abrasion from moving screened material (30).

It is further proposed that a system and method be provided which protects components of a trommel frame structure from abrasion, but which also allows quick assembly and solves one, some, or all the aforementioned disadvantages.

It is yet a further object of the invention to provide a quick connection system for a protective cover and suitable modular protective cover design, which might allow maintenance personnel to quickly target, identify, and isolate damaged protective covers and easily replace them with spare protective covers by hand (i.e., without the need for large complex tools or heavy machinery).

Other details, objects, and advantages of the invention will become apparent as the following description of certain present preferred embodiments thereof and certain present preferred methods of practicing the same proceeds.

### SUMMARY OF THE INVENTION

A protective cover (10) may be provided. The protective cover (10) may be adapted for removably affixing it to a trommel frame section (1) of a trommel device. The protective cover (10) may be configured to protect portions of the trommel frame section (1) from abrasion and wear from screened material (30) being processed by the trommel device. In some embodiments, the protective cover (10) may comprise a body (19), from which one or more (preferably a plurality of) fixation members (11) extend. The fixation members (11) are preferably adapted to surround a cross brace (5), longitudinal support (7), or radial support (8) of the trommel frame section (1), without limitation.

One or more locking features (15) may be provided to the fixation members (11) for securing the body (19) to the surrounded cross brace (5), longitudinal support (7), or radial support (8) of the trommel frame section (1) to be protected from wear. An opening (17) provided between the fixation members (11) may be provided to the protective cover (10). The opening (17) may be adapted for accepting, receiving, and/or retaining said surrounded cross brace (5), longitudinal support (7), or radial support (8) of the trommel frame section (1) to be protected from wear. The cross-sectional shape of the opening (17) is preferably complimentary to the cross-sectional shape of said surrounded cross brace (5), longitudinal support (7), or radial support (8) of the trommel frame section (1) to be protected from wear.

In the non-limiting particular embodiment shown, a rectangular opening (17) is shown to accept a rectangular component (e.g., cross brace (5)) of a trommel frame section (1). However, it should be understood that the opening (17) could take on different shapes (e.g., round, triangular, polygonal, “C”-shaped, cupped, etc.) to match cross-sectional profiles of a trommel frame section (1), without limitation.

A protective cover (10) may, in some non-limiting embodiments, further comprise one or more securement features (20). The one or more securement features (20) of the protective cover (10) may be configured for engaging one or more securement features (4) provided to the trommel frame section (1). A protective cover (10) may, in some non-limiting embodiments, comprise first (12) and second (13) deflection surfaces which are configured to deflect screened material (30) around the protective cover and/or around portions of a trommel frame section (1). Deflection radii/chamfers (18) may be optionally provided for similar purposes. In some embodiments, the one or more locking features (15) provided to a protective cover (10) may further comprise a flex radius or chamfer (16) to facilitate spreading of the fixation members (11), without limitation.

In some embodiments, an interference width (D), represented by the minimum distance between the one or more locking features (15), may be smaller than a dimension of cross brace (5) of the trommel frame section (1) and/or smaller than an opening width (A) of the opening (17), without limitation.

A trommel frame section (1) of a trommel device may comprise a removably-affixed protective cover (10). The protective cover (10) may be configured to protect portions of the trommel frame section (1) from abrasion and wear from screened material (30) being processed by the trommel device. The protective cover (10) provided to the trommel frame section (1) may be as described above in paragraphs [13-17], or may comprise any combination of the features described above in paragraphs [13-17].

A trommel device may comprise a protective cover (10) removably-affixed to a trommel frame section (1) of a trommel frame (50). The protective cover (10) may be configured to protect portions of the trommel frame section (1) and trommel frame (50) from abrasion and wear from screened material (30) being processed by the trommel device. The protective cover (10) provided to the trommel device may be as described above in paragraphs [13-17], or may comprise any combination of the features described above in paragraphs [13-17].

### BRIEF DESCRIPTION OF THE DRAWINGS

To complement the description which is being made, and for the purpose of aiding to better understand the features of the invention, a set of drawings illustrating a preferred, non-limiting embodiment of a protective cover (10) and a method of securing the same to a section (1) of a trommel frame (50) is attached to the present specification as an integral part thereof, in which the following has been depicted with an illustrative and non-limiting character. It should be understood that like reference numbers used in the drawings may identify like components.

Non-limiting and non-exhaustive embodiments of the disclosure are described, including various embodiments of the disclosure, with reference to the figures, in which:

FIG. 1 illustrates a partial isometric view of an outside portion of a trommel device employing a protective cover (10) on a trommel frame section (1), according to some non-limiting embodiments.

FIG. 2 illustrates a 3D cutaway section view of a protective cover (10) secured to a trommel frame section (1), according to some non-limiting embodiments.

FIG. 3 illustrates a cross-sectional view through a protective cover (10), according to some non-limiting embodiments.

FIG. 4 depicts how a protective cover (10) may be adequately configured to deflect screened material (30) around a trommel frame section (1), according to some non-limiting embodiments.

FIG. 5 illustrates a side view of a protective cover (10), according to some non-limiting embodiments.

FIG. 6 illustrates a top view of a protective cover (10), according to some non-limiting embodiments.

FIG. 7 illustrates a bottom view of a protective cover (10), according to some non-limiting embodiments.

FIG. 8 illustrates two protective covers (10) joined together, according to some non-limiting embodiments.

FIG. 9 illustrates an apparatus comprised of four protective covers (10), according to some non-limiting embodiments.

FIG. 10 illustrates the protective cover (10) of FIG. 9, installed on a trommel frame section (1), according to some non-limiting embodiments.

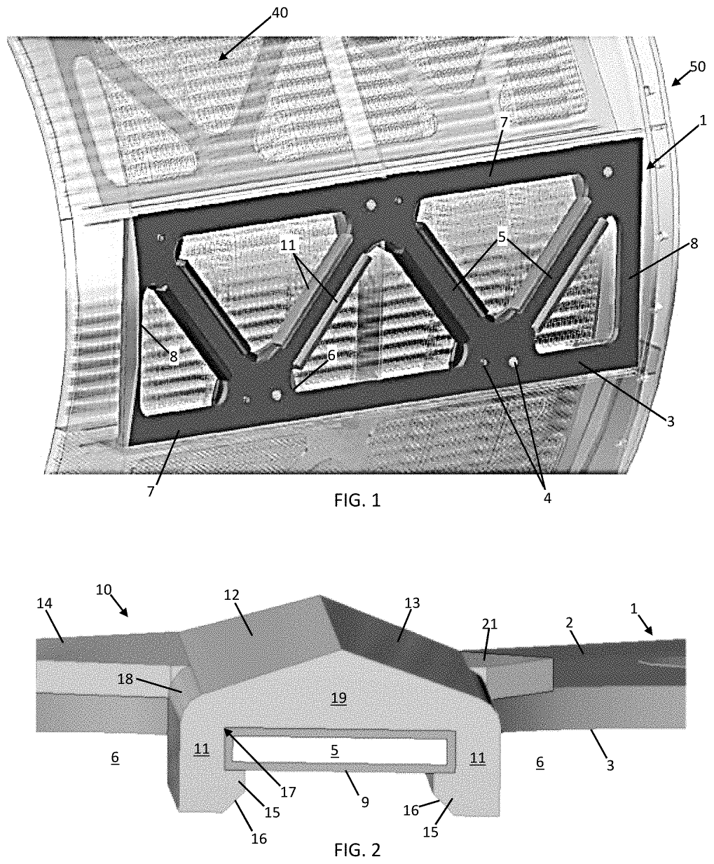

In the following, the invention will be described in more detail with reference to drawings in conjunction with exemplary embodiments.

### DETAILED DESCRIPTION

The present specification provides disclosure for embodiments of a protective cover (10) for protecting portions of a trommel device (in particular, one or more trommel frame sections (1) and/or inside surfaces thereof) which may be prone to wear from screened material (30). The present disclosure further provides disclosure for a method of installing a protective cover (10), removing a protective cover (10), and/or retrofitting of a trommel device to incorporate one or more protective covers (10) with one or more trommel frame sections (1), without limitation.

A trommel device may comprise a consumable tubular trommel screen (40) radially supported by a non-consumable tubular trommel frame (50). The trommel frame (50) may be modular or it may be provided as a single unitary piece or integral monolithic structure, without limitation. The trommel frame (50) may comprise a number of trommel frame sections (1) provided about its periphery/circumference with each forming a portion of the trommel frame (50).

An inner face (2) of a trommel frame section (1) which faces radially-inwardly and/or is most exposed to abrasion by screened material (30) may be concave, or it may be generally planar. Each trommel frame section (1) may conceptually represent a facet of the entire trommel frame (50). Trommel frame sections (1) may serve to radially support the trommel screen (40) which is generally provided radially inwardly with respect to the trommel frame (50).

A trommel frame section (1) may comprise one or more trommel frame section longitudinal supports (7), and one or more trommel frame section radial supports (8) thereby forming a mainframe of the trommel frame segment (1). The longitudinal supports (7) and radial supports (8) may be configured differently in shape, thickness, number, size, and/or orientation than what is shown, without limitation.

One or more cross braces (5) may be provided between and/or across the longitudinal (7) and/or radial supports (8) to provide further robustness to a trommel frame section (1) and/or stiffen the trommel frame (50). Cross braces (5) may, as shown, be configured to be angled or extend diagonally with respect to longitudinal (7) and/or radial (8) supports, so as to form a truss-like trommel frame section (1). While not shown, cross braces (5) may extend orthogonally or in parallel relationship to longitudinal (7) and/or radial (8) supports, without limitation. It should be understood that the cross braces (5) may be configured differently in shape, thickness, number, size, and/or orientation than what is shown, without limitation.

Trommel frame sections (1) may further have openings (6) between cross braces (5), longitudinal supports (7), and/or radial supports (8), as shown without limitation.

In some embodiments, one or more liners or coatings (9) may be applied to or may already exist on a trommel frame section (1), without limitation. For example, a polymeric and/or elastomeric substance may be provided over a metallic core substrate to form the body of a trommel frame section (1), without limitation. In some embodiments, for example, a polyurethane coating between 1 mm and 10 mm thick (e.g., approximately 4-6 mm thick) may be applied over a metal trommel frame section (1) skeleton, without limitation. The one or more liners or coatings (9) may include one or more layers of epoxy or paint, without limitation. The one or more liners or coatings (9) may also broadly include any number of wear mats or pads affixed to a skeletal substrate by fasteners or adhesives, without limitation.

One or more securement features (4) may further be provided to a trommel frame section (1). The one or more securement features (4) may serve to secure one or more protective covers (10) to a trommel frame section (1). The one or more trommel frame securement features (4) may, as shown, be configured to accept one or more protective cover securement features (20), without limitation. The securement features (4) of a trommel frame section (1) may be provided as apertures, without limitation. The apertures may be smooth, threaded, ribbed, countersunk, or have another suitable configuration, without limitation. The protective cover securement features (20) may be, for example, provided as screws, bolts, roll pins, snap-lock fasteners, or as bifurcated locking pegs which may be provided with a radially-outwardly extending lip or ribs extending outwardly from a periphery of each leg, without limitation. Other securement features such as adhesives or industrial strength hook and loop fastener strips may be utilized to secure protective covers (10) to trommel frame sections (1), without limitation. Protective cover securement features (20) may be integrally-provided to a protective cover (10), for example, by moulding them with the body (19) during manufacturing.

It should be understood that while not shown, in some embodiments, the one or more securement features (4) provided to a trommel frame section (1) may instead be male, and the one or more securement features (20) provided to a protective cover (10) may instead be female. In this regard, the protective cover securement features (20) may accept, receive, and/or secure one or more trommel frame section securement features (4), inversely to what is shown, without limitation.

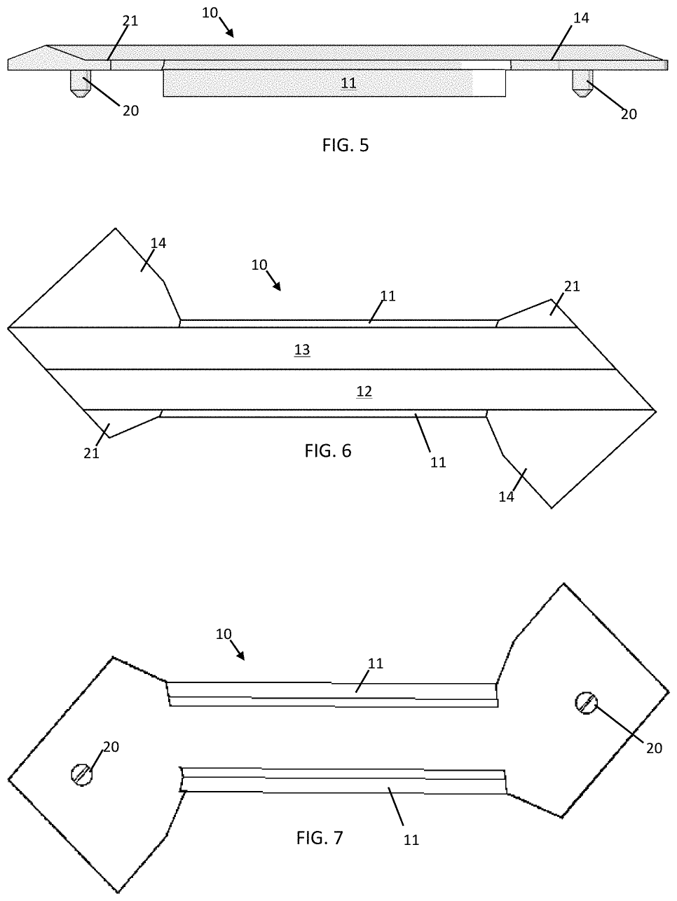

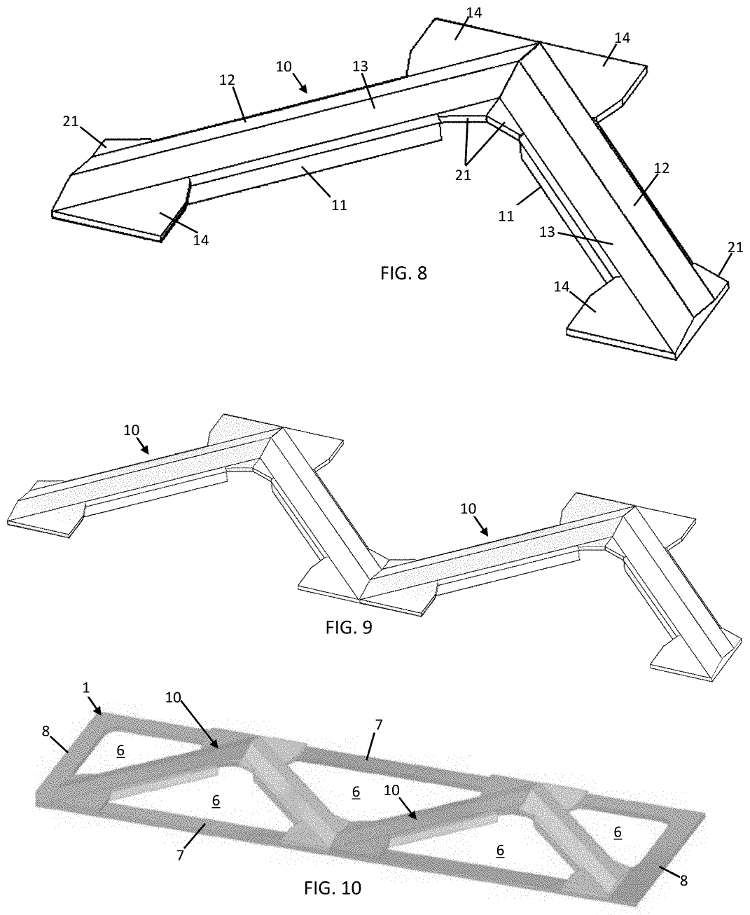

Turning now to FIGS. 2-9, one or more protective covers (10) may be provided for protecting one or more portions of a trommel frame section (1). In particular, the one or more protective covers (10) are configured to adequately protect vulnerable surfaces and areas of substrate material (5) forming the trommel frame section (1) which may even include optional coatings or liners (9). The one or more protective covers (10) are preferably also configured to adequately protect radially-inwardly facing portions of a trommel frame section (1) which face a trommel screen (40) and/or which may be most susceptible to exposure to screened material (30) and wear therefrom.

A protective cover (10) may comprise one or more fixation members (11), for example, which may be provided in the form of elongated locking fingers running along a length of the protective cover body (19), without limitation. The one or more fixation members (11) may be configured to engage an outer portion of a trommel frame section (1), for example, an exterior surface and/or edge portion of a cross brace (5) thereof as shown. In the exemplary, non-limiting, preferred embodiment shown, the one or more fixation members (11) comprise two juxtaposed elongated locking fingers defining an opening (17) therebetween.

The opening (17) may be further defined by locking features (15) which may comprise, for instance, a number of snap-lock tabs extending inwardly from the fixation members (11) and/or towards each other. As shown, locking features (15) may incorporate one or more flex radii or chamfers (16) which may help enable the fixation members (11) to spread apart and create temporary clearance for a cross brace (5) portion of a trommel frame section (1), a longitudinal support (7) of a trommel frame section (1), or a radial support (8) of a trommel frame section (1) to enter or leave opening (17), without limitation.

A first deflection surface (12), which may be angled as shown in the figures, may be provided to a trommel screen-facing side of a protective cover (10). A second deflection surface (13), which may be angled as shown in the figures, may further be provided to a trommel screen-facing side of a protective cover (10) adjacent the first deflection surface (12), without limitation. As schematically-depicted in FIG. 4, the first (12) and second (13) deflection surfaces may meet together to form an apex therebetween. The apex (and configuration of first (12) and second (13) deflection surfaces) may be configured to adequately direct or deflect screened material (30) to either side of the body (19) of the protective cover (10) as shown.

To further assist screened material (30) flow and prevent clogging of screened material (30), one or more one or more deflection radii or chamfers (18) may be provided to the protective cover (10) between the body (19) and fixation members (11) to adequately direct or deflect screened material (30) to either side of the body (19) of the protective cover (10) as shown.

For additional support and stability, a protective cover (10) may, in some embodiments, incorporate one or more first flanges (14) and/or one or more second flanges (21) extending out from one or both ends of the protective cover (10). As shown, as a matter of design preference, a first flange (14) may be larger than a second flange (21) to improve the overall configuration of protective covers (10) when assembled, without limitation.

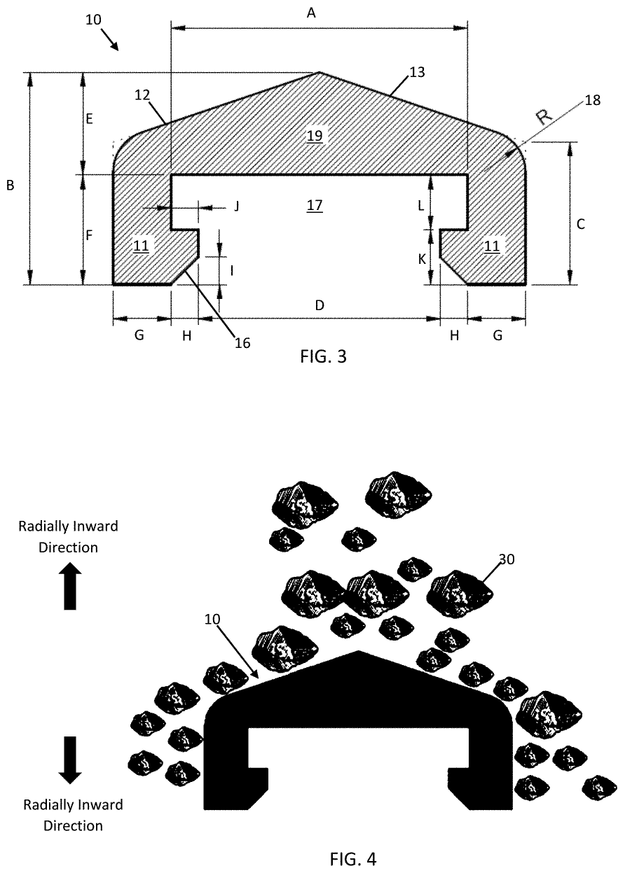

Turning now to FIG. 3, which represents a side cutaway view of a protective cover (10) according to some embodiments, an opening width (A) may be provided which is complementary to a width of a cross brace (5) of a trommel frame section (1). A protective cover (10) may have a protective cover height (B), a deflection height (C), and a body height (E), without limitation. A protective cover (10) may also comprise an interference width (D) between locking features (15), without limitation.

A fixation member height (F) may exist which may be less than the deflection height (C) and which may be greater than a locking feature height (K), without limitation.

Each fixation member (11) may comprise a fixation member width (G). Preferably, fixation member width (G) is designed to allow appropriate flexing of fixation members (11). Each flex radii or chamfer (16), if optionally provided to a locking feature (15), may comprise a flex radius/chamfer width (H) and a flex radius/chamfer height (I), without limitation. The flex radius/chamfer width (H) and flex radius/chamfer height (I) may be adequately configured to require minimal push on force to secure a protective cover (10) to a trommel frame section (1), but maximum pull-off force to ensure that the protective cover (10) remains sufficiently secured to the trommel frame section (1) during trommel device screening operations. Protective covers (10) may be designed to be removed by force using a tool to separate fixation members (11), by complete destruction, and/or by coaxing fixation members (11) from a locked position (e.g., to increase interference width (D) such that a cross brace (5) can be removed from opening (17)).

Locking features (15) may comprise a locking feature width (J) forming an undercut portion of opening (17), as shown. An opening height (L) of opening (17) is preferably large enough to accept a cross brace (5) portion of a trommel frame section (1), a longitudinal support (7) of a trommel frame section (1), or a radial support (8) of a trommel frame section (1), without excessive interference/friction. The opening height (L) and the opening width (A) is preferably sized to accommodate a trommel frame section (1) and compensate for any trommel frame section liners or coatings (9) which may be provided to a trommel frame section (1).

Protective covers (10) disclosed herein may be provided using various materials. They may be fabricated from metal, ceramic, and/or polymeric materials. In some embodiments, protective covers (10) may comprise a combination of different materials (e.g., a combination of metal and plastic). In some preferred embodiments, for example, a protective cover may comprise a solid polyurethane material which may, for example, have a hardness defined between 70 on the Shore “A” scale to about 85 on the Shore “A” scale, without limitation.

In some embodiments, fixation between the protective covers (10) and trommel frame sections (1) may be made by virtue of temporary or semi-permanent interference, wherein once a protective cover (10) is affixed or assembled to a portion of a trommel frame section (1), it is interlaced and embraces the structure but remains removable.

Reference throughout this specification to “one embodiment” or “an embodiment” means that a particular feature, structure, or characteristic described in connection with the embodiment may be included in at least one embodiment. Thus, the appearances of the phrases “in one embodiment” or “in an embodiment” in various places throughout this specification are not necessarily all referring to the same embodiment. In particular, “an embodiment” may be a system, an article of manufacture, a method, or a product of a process. Not all of the described features need to be necessarily incorporated into a particular embodiment together to provide utility. Rather, it will be appreciated by those skilled in the art that a particular embodiment may comprise any conceivable combination of features or elements shown or described.

The phrases “connected to,” “in communication with,” “accepting,” “receiving,” “securing to,” “complementary with,” and the like generally refer to any form of interaction between two or more components, including mechanical, electrical, magnetic, and electromagnetic interaction. Two components may be connected to each other even though they are not in direct contact with each other and even though there may be intermediary devices between the two components.

Where used herein, the term “protective cover” may include or comprise a plurality of individual protective cover sections, or it may comprise a single piece protective apparatus, without limitation. The term “protective cover,” where used herein, may refer to a protective cover section which may be combined with other protective cover sections to form a protective cover for a trommel frame (50) or for a trommel frame section (1), without limitation. While not shown, in some embodiments, a single, unitary, monolithic protective cover (10) may protect an entire trommel frame section (1), without limitation. In some embodiments, as shown, multiple protective covers (10) may be used to protect a trommel frame section (1), without limitation. In some embodiments, multiple protective cover sections may be used to protect a trommel frame (50), without limitation.

Where used herein “trommel frame section” (1) may be broadly interpreted to include any portion of a trommel frame (50), whether that portion may be a modular component of a trommel frame (50) or a permanent component of a trommel frame (50).

In some cases, well-known features, structures, or operations are not shown or described in detail, for purposes of succinctness and brevity. Furthermore, the described features, structures, or operations may be combined in any suitable manner in one or more embodiments. It is anticipated that the components of the embodiments, as generally described and illustrated in the figures herein, could be arranged and designed in a wide variety of different configurations. In addition, the steps of the described methods do not necessarily need to be executed in any specific order, or even sequentially, nor need the steps be executed only once, unless otherwise specified.

The embodiments of the disclosure are best understood by reference to the drawings, wherein like parts are designated by like numerals throughout. In the foregoing description, numerous details are provided to give a thorough understanding of various embodiments; however, the embodiments disclosed herein can be practiced without one or more of the specific details, or with other methods, components, materials, and the like. Well-known structures, materials, or operations are not shown or described in detail to avoid obscuring aspects of this disclosure.

Furthermore, a contractor or other entity may provide, or be hired to provide, the apparatus and/or method such as those disclosed in the present specification and shown in the figures. For instance, a contractor may receive a bid request for a project related to designing a protective cover (10) for a trommel frame (50) or trommel frame segment (1); or, a contractor may offer to design such a method and accompanying system. The contractor may then provide the apparatus and/or method in a manner consistent with the inventive aspects discussed herein. The contractor may provide such an apparatus and/or method by selling the apparatus and/or method or by offering to sell the apparatus and/or method. The contractor may provide such an apparatus and/or method by selling and/or by offering to sell the various accompanying parts and equipment to be used with and/or for said method.

The contractor may provide a method and/or related equipment that are configured to meet the design criteria of a client or customer. The contractor may subcontract the fabrication, delivery, sale, or installation of a component or feature of, or of any of the devices or of other devices contemplated for use with the method. The contractor may also maintain, modify or upgrade the provided devices and their use within the general method. The contractor may provide such maintenance or modifications by subcontracting such services or by directly providing those services.

### LISTING OF REFERENCE NUMERAL IDENTIFIERS

1. Trommel frame section
2. Inner face
3. Outer face
4. Trommel frame section securement feature(s)
5. Trommel frame section cross brace(s)
6. Trommel frame section opening(s)
7. Trommel frame section longitudinal support(s)
8. Trommel frame section radial support(s)
9. Trommel frame section liner/coating(s)
10. Protective cover or cover section(s)
11. Fixation member(s)
12. First (e.g., angled) deflection surface
13. Second (e.g., angled) deflection surface
14. First Flange(s)
15. Locking feature(s) (E.g., one or more snap-lock tab(s))
16. Flex radius/chamfer(s)
17. Opening
18. Deflection radius/chamfer(s)
19. Body
20. Protective cover securement feature(s)
21. Second flange(s)
30. Screened material
40. Trommel screen
50. Trommel frame
A Opening width
B Protective cover height
C Deflection height
D Interference width
E Body height
F Fixation member height
G Fixation member width
H Flex radius/chamfer width
I Flex radius/chamfer height
J Locking feature width (e.g., snap-lock tab width)
K Locking feature height (e.g., snap-lock tab height)
L Opening height

1.-15. (canceled)

16. A protective cover configured to be removably affixed to a trommel frame section of a trommel frame and being configured to protect portions of the trommel frame section from abrasion and wear from screened material; the protective cover comprising:
a body;
fixation members extending from the body; each of the fixation members comprising a fixation member width and a fixation member height; the fixation member width being configured to allow flexing of the fixation members;
one or more locking features provided to the fixation members for securing the body to the trommel frame section; the one or more locking features extending inwardly from the fixation members and towards each other; each locking feature having a locking feature width; the one or more locking features comprising a flex radius or chamfer to facilitate spreading of the fixation members; and,
an opening provided between the fixation members which is adapted for receiving and retaining a cross brace, longitudinal support, or radial support of the trommel frame section; the opening comprising an opening width and an opening height;
wherein an interference width defining the minimum distance between the one or more locking features, is smaller than the opening width; and
wherein the protective cover is configured such that a push on force is used to secure the protective cover to the trommel frame section.

17. The protective cover according to claim 16, further comprising one or more securement features which are configured for engaging one or more securement features provided to the trommel frame section.

18. The protective cover according to claim 16, further comprising first and second deflection surfaces.

19. A trommel frame comprising the protective cover according to claim 16.

20. A method of protecting a trommel frame comprising:
providing the protective cover according to claim 16; and
applying a push on force to the protective cover to secure the protective cover to a trommel frame section of the trommel frame.
